(19) United States
(12) Patent Application Publication
(10) Pub. No.: US 2016/0199677 A1
(43) Pub. Date: Jul. 14, 2016

(54) EMERGENCY ESCAPE BREATHING SYSTEM

(71) Applicant: Chase D. Lewis, Chapel Hill, NC (US)

(72) Inventor: Chase D. Lewis, Chapel Hill, NC (US)

(21) Appl. No.: 14/595,326

(22) Filed: Jan. 13, 2015

(51) Int. Cl. A62B 25/00; A62B 18/02; A62B 18/08; A62B 23/02

(52) U.S. Cl. CPC A62B 25/00; A62B 23/025; A62B 18/02; A62B 18/08

(57) ABSTRACT

An emergency escape breathing system having a delivery container including a first portion and a second portion that are releasably secured to each other, the delivery container defining an interior compartment, and a smoke filtration mask disposed within the interior compartment of the delivery container, wherein the delivery container is configured so that the emergency escape breathing system may be grasped and thrown by a hand of a user.

### FIELD OF THE INVENTION

The present invention relates generally to emergency escape devices. More particularly, the present invention relates to a system for delivering emergency escape devices, such as smoke masks and goggles, to persons in hazardous environments.

### BACKGROUND OF THE INVENTION

Each year, upwards of 2,500 people lose their lives in the United States as a result of home structure fires, with approximately 40% of those deaths due to being overcome by the inhalation of noxious smoke and fumes. Statistics indicate that 71% of these fires occur in one and two family homes that do not exceed two stories of living space. As would be expected, many of these deaths occur on the upper stories of the structures where the occupants' egress may be hindered or prevented by smoke and fumes, as well as fire. Often, evacuation of occupants on the upper stories of these structures requires the assistance of emergency response personnel. Of course, the time span between notification of the emergency response personnel and their subsequent arrival is vital as it can mean the difference between life and death for the occupants.

As the occupants await assistance, they are often exposed to unsafe levels of smoke which includes particulate matter, carbon monoxide, acids, various toxins, etc. Of note, carbon monoxide is a cumulative toxin which, when inhaled, can quickly reach levels in the blood stream that may lead to disorientation, confusion, reduced mental acuity and compromised judgment, therefore reducing the occupants' probability of successfully exiting the burning structure.

Deaths due to smoke inhalation are exacerbated in rural areas in that the corresponding fire departments tend to be manned by volunteer personnel, as opposed to urban fire departments which often have paid, career emergency personnel. Seventy percent of fire departments in the United States are 100% volunteer personnel. As would be expected, emergency response times by the volunteer fire departments tend to be longer than those of the fire departments manned around the clock by career firefighters. As such, it is not uncommon for the first responders on the scene of a rural fire to be police, Emergency Medical Services (EMS), volunteer firefighters in personal vehicles, etc. However, these people are often not suited for entry into the burning structure to assist the occupants.

The present invention recognizes and addresses considerations of prior art constructions and methods.

### SUMMARY OF THE INVENTION

One embodiment of the present disclosure provides an emergency escape breathing system having a delivery container including a first portion and a second portion that are releasably secured to each other, the delivery container defining an interior compartment, and a smoke filtration mask disposed within the interior compartment of the delivery container, wherein the delivery container is configured so that the emergency escape breathing system may be grasped and thrown by a hand of a user.

Another embodiment of the present disclosure provides an emergency escape device delivery system having a delivery container including a first portion and a second portion that are releasably secured to each other, the delivery container defining an interior compartment and being comprised of a translucent material, a smoke filtration mask disposed within the interior compartment of the delivery container, and a light source disposed within the interior compartment of the delivery container, the light source being visible through the delivery container, wherein the delivery container is configured so that the emergency escape breathing system may be grasped and thrown by a hand of a user.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1A is an elevational view of an emergency escape breathing system in accordance with a first embodiment of the present disclosure;

FIG. 1B is a perspective view of a delivery container of the emergency escape breathing system shown in FIG. 1, in the open configuration;

FIG. 1C is a perspective view of the delivery container shown in FIG. 1B with an alternate closure mechanism;

FIG. 2A is a perspective view of a second embodiment of a delivery container in accordance with the present disclosure, in the closed configuration;

FIG. 2B is a perspective view of the second embodiment of a delivery container in accordance with the present disclosure, in the open configuration;

FIG. 3A is a perspective view of a third embodiment of a delivery container in accordance with the present disclosure, in the closed configuration;

FIG. 3B is a perspective view of the third embodiment of a delivery container in accordance with the present disclosure, in the open configuration;

FIG. 4 is a perspective view of a fourth embodiment of a delivery container in accordance with the present disclosure, in the open configuration;

FIG. 5 is a view of the contents of the emergency escape breathing system shown in FIG. 1A; and

FIG. 6 is a perspective view of an emergency responder delivering the emergency escape breathing system shown in FIG. 1A into a burning structure.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

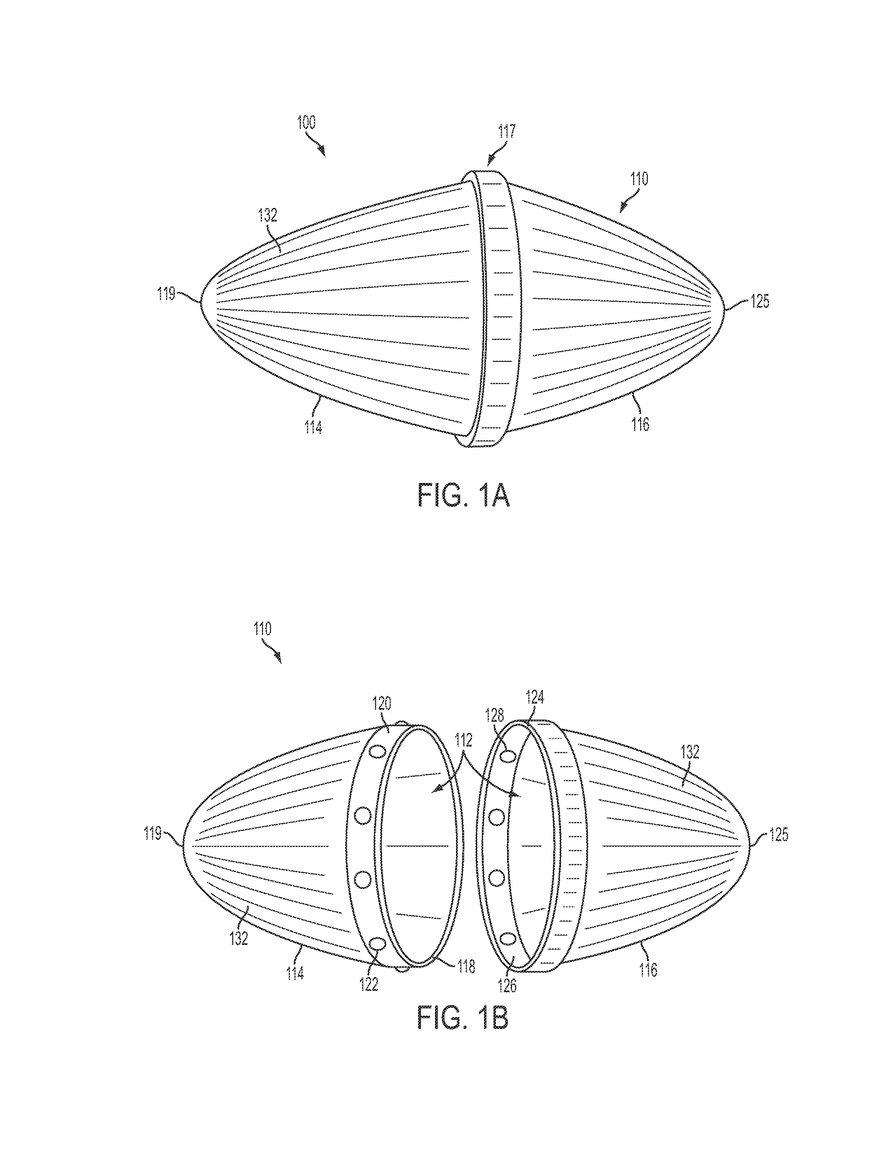

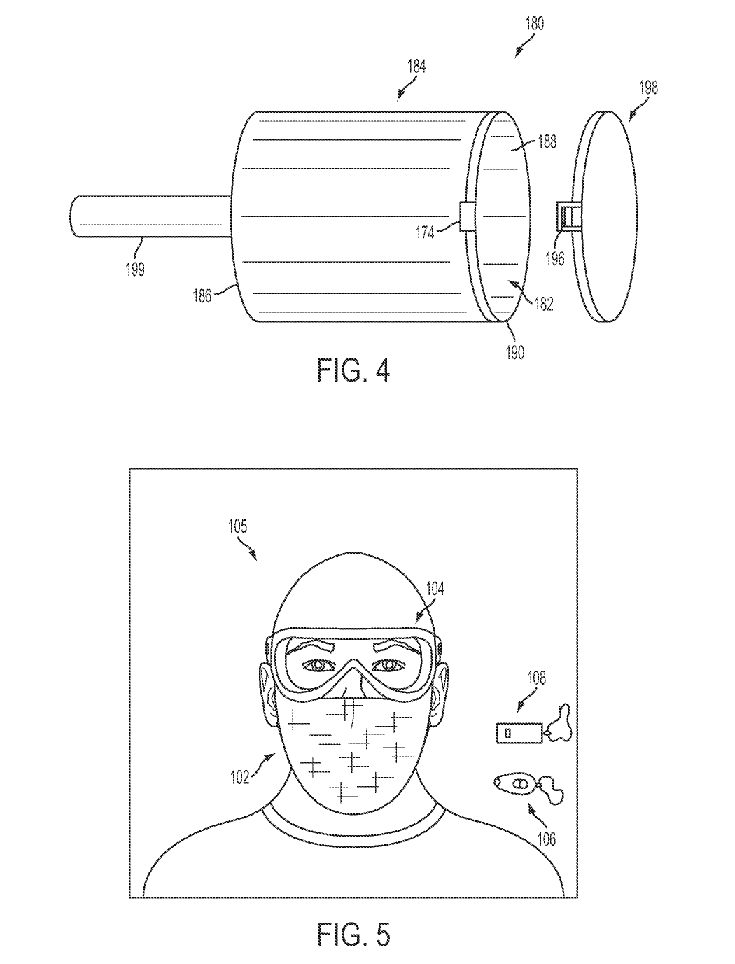

Referring now to FIGS. 1A and 1B, an emergency escape breathing system 100 in accordance with an embodiment of the present invention is shown. Emergency escape breathing system 100 preferably includes a delivery container 110 that defines an interior compartment 112 for receiving articles, such as, but not limited to, a smoke filtration mask 102, goggles 104, a light emitting diode (LED) light source 106, and a whistle 108, as shown in FIG. 5. In the embodiment shown, delivery container 110 is a substantially football-shaped container defined by a first half portion 114 and a second half portion 116 that are removably secured to each other at a central portion 117 of the container Delivery container 110 is preferably formed of an injection molded polypropylene, or other like material, that is both lightweight and shatter resistant. Additionally, a heat-resistant material would be preferable. Delivery container 110 is preferably formed of a translucent or transparent material. This allows a light source, such as, but not limited to, an LED light, light stick, etc., to be placed in the delivery container yet remain visible to a potential evacuee that is attempting to locate the emergency escape breathing system 100.

As best seen in FIG. 1B, first half portion 114 and second half portion 116 each have a first end that includes a circular rim portion 118 and 124, and a second end that forms a slightly rounded apex 119 and 125, respectively. The rounded apexes 119 and 125 and cone-shaped outer surfaces of first half portion 114 and second half portion 116 facilitate the user's ability to throw emergency escape breathing system 100 into a burning structure, such as through a window opening, as discussed in greater detail below.

As best seen in FIG. 1B, first half portion 114 includes an annular band 120 that is adjacent rim portion 118 and defines a plurality of projections 122 extending radially outward from its outer surface. Second half portion 116 includes an annular band 126 that defines a plurality of recesses 128, each recess 128 extending radially outward from an inner surface of annular band 126 and being correspondingly shaped to the shape of the projections 122. As shown, each projection 122 of first half portion 114 is selectively receivable in a corresponding one of the plurality of recesses 128 of second half portion 116. Projections 122 are preferably shaped so that first half portion 114 and second half portion 116 of delivery container 110 remain together upon impact, such as when delivery container 110 has been thrown, as discussed in greater detail below, yet allow the user to readily open delivery container 110 to retrieve the objects therein. Note, however, in alternate embodiments, the projections and correspondingly shaped recesses may be any number of shapes, such as, but not limited to, rectangular, square, triangular, etc. Preferably, outer surface 130 of delivery container 110 includes ribbing 132 or an alternately textured pattern, to facilitate a user's ability to grasp and throw delivery container 110. As well, first half portion 114 and second half portion 116 may be formed such that central portion 117 forms a smooth transition between the first and second half portions on the outside of the delivery container.

Referring now to FIG. 1C, an alternate embodiment of a delivery container 110a for use with emergency escape breathing system 100 is shown. Delivery container 110a is substantially similar to the previously discussed embodiment in that it has a first half portion 114 and a second half portion 116 that are releasably secured to each other, thereby defining an interior compartment 112 for receiving emergency escape items, such as those shown in FIG. 5. However, in place of radially extending projections and recesses, as a means of releasably securing first half portion 114 and second half portion 116, delivery container 110a includes correspondingly threaded surfaces for releasably securing the first and second half portions to each other. As shown, the outer surface of annular band 120 of first half portion 114 and the inner surface of annular band 126 of second half portion 116 are correspondingly threaded. Preferably, threads that are both short and coarse are formed on annular band 120a and annular band 126a so that first half portion 114 and second half portion 116 of delivery container 110a may be alternatingly secured to each other and released from each other by a partial turn with respect to each other. As such, first half portion 114 and second half portion 116 of delivery container 110a will remain connected upon impact, yet can be separated from each other by only a partial turn of the two halves with respect to each other.

Similarly to the previously discussed embodiment of delivery container 110, delivery container 110a is preferably formed of an injection molded polypropylene, or other like material, that is lightweight, shatter resistant, and preferably heat resistant. As well, delivery container 110a is preferably formed of a translucent or transparent material. This allows a light source, such as, but not limited to, an LED light, light stick, etc., to be placed in the delivery container yet remain visible to a potential evacuee that is attempting to locate the emergency escape breathing system 100.

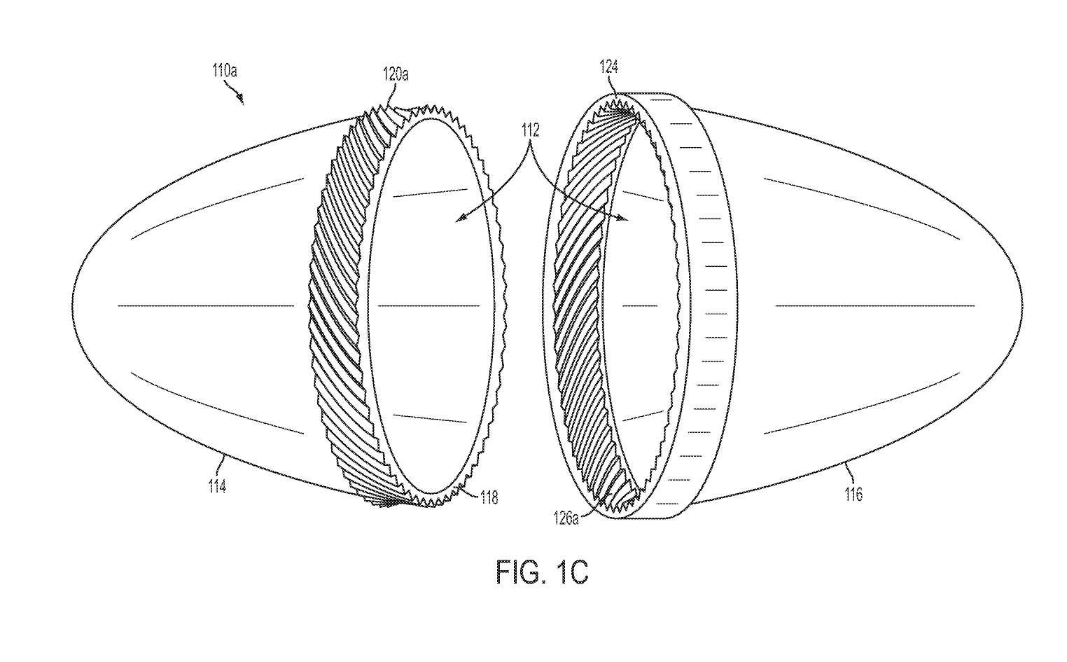

Referring now to FIGS. 2A and 2B, yet another embodiment of a delivery container 150 in accordance with the present disclosure is shown. Delivery container 150 is substantially bullet-shaped, having a substantially cylindrical body 154 and a cone-shaped nose piece 156 that define an interior compartment 152 for receiving emergency escape objects, such as those shown in FIG. 5. As shown, body 154 includes a circular base 158, a frustoconical end wall 162 and a cylindrical side wall 160 extending therebetween. Frustoconical end wall 162 terminates in a circular rim 164 that is configured to abut a corresponding circular rim 172 of nose piece 156.

A pair of catches 166 releasably secure nose piece 156 to body 154 of delivery container 150. Each catch 166 includes an aperture 168 defined by end wall 162 of body 154, and a corresponding projection 170 that extends radially outwardly from, and is adjacent to, rim 172 of nosepiece 156. Catches 166 removably secure nose piece 156 to body 154, so that the two portions remain assembled upon impact, yet are easily separated by a user that is removing the emergency escape items from within. Delivery container 150 is preferably formed of an injection molded polypropylene, or other like material, that is lightweight, shatter resistant, and preferably heat resistant. As well, delivery container 150 is preferably formed of a translucent or transparent material. This allows a light source, such as, but not limited to, an LED light, light stick, etc., to be placed in the delivery container yet remain visible to a potential evacuee that is attempting to locate the emergency escape breathing system 100. As previously noted, nose piece 156 is substantially cone-shaped. The cone-shaped outer surface 174 of nose piece 156 facilitates the entry of delivery container 210 into a burning structure, such as through a window opening, as discussed in greater detail below.

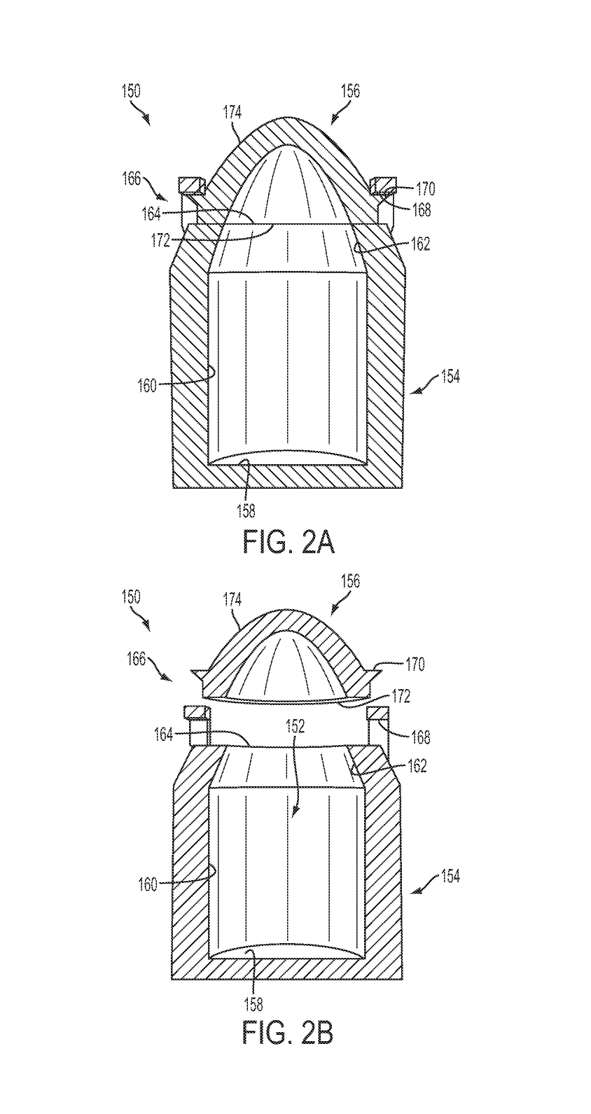

Referring now to FIGS. 3A and 3B, an alternate embodiment of a delivery container 210 in accordance with the present disclosure is shown. As shown, delivery container 210 is a substantially round container defined by a first half portion 214 and a second half portion 216 that are releasably secured to each other at a central portion 217 of the container. As best seen in FIG. 3A, first half portion 214 and second half portion 216 have a first end that includes a circular rim portion 218 and 224, and a second end that is formed by a rounded apex 219 and 225, respectively. Delivery container 210 is preferably formed of an injection molded polypropylene, or other like material, that is lightweight, shatter resistant, and preferably heat resistant. As well, delivery container 210 is preferably formed of a translucent or transparent material. This allows a light source, such as, but not limited to, an LED light, light stick, etc., to be placed in the delivery container yet remain visible to a potential evacuee that is attempting to locate the emergency escape breathing system 100.

As best seen in FIG. 3A, first half portion 214 includes an annular band 220 that is adjacent rim portion 218 and defines a plurality of projections extending radially outward from its outer surface. Second half portion 216 includes an annular band 226 that defines a plurality of correspondingly shaped recesses 228, each recess 228 extending radially outward from an inner surface of annular band 226. As shown, each projection 222 of first half portion 214 is selectively receivable in a corresponding one of the plurality of recesses 228 of second half portion 216. Projections 222 are preferably shaped so that first half portion 214 and second half portion 216 of delivery container 210 remain together upon impact, such as when delivery container 210 has been thrown, as discussed in greater detail below, yet allow the user to readily open delivery container 210 to retrieve the objects therein. Note, however, in alternate embodiments, the projections and correspondingly shaped recesses may be any number of shapes, such as, but not limited to, rectangular, square, triangular, etc. Preferably, the outer surface of delivery container 210 preferably includes ribbing or an alternately textured pattern, to facilitate a user's ability to grasp and throw delivery container 210.

In yet another alternate embodiment, delivery container 210 may include correspondingly threaded surfaces so that first half portion 214 and second half portion 216 may be releasably secured to each other. Specifically, the outer surface of annular band 220 of first half portion 214 and the inner surface of annular band 226 of second half portion 216 may be correspondingly threaded, such as the delivery container 110a shown in FIG. 1C. Preferably, threads that are both short and coarse may be formed on annular band 220 and annular band 226 so that first half portion 214 and second half portion 216 of delivery container 210 may be alternatingly secured to each other and released from each other by approximately a partial turn with respect to each other.

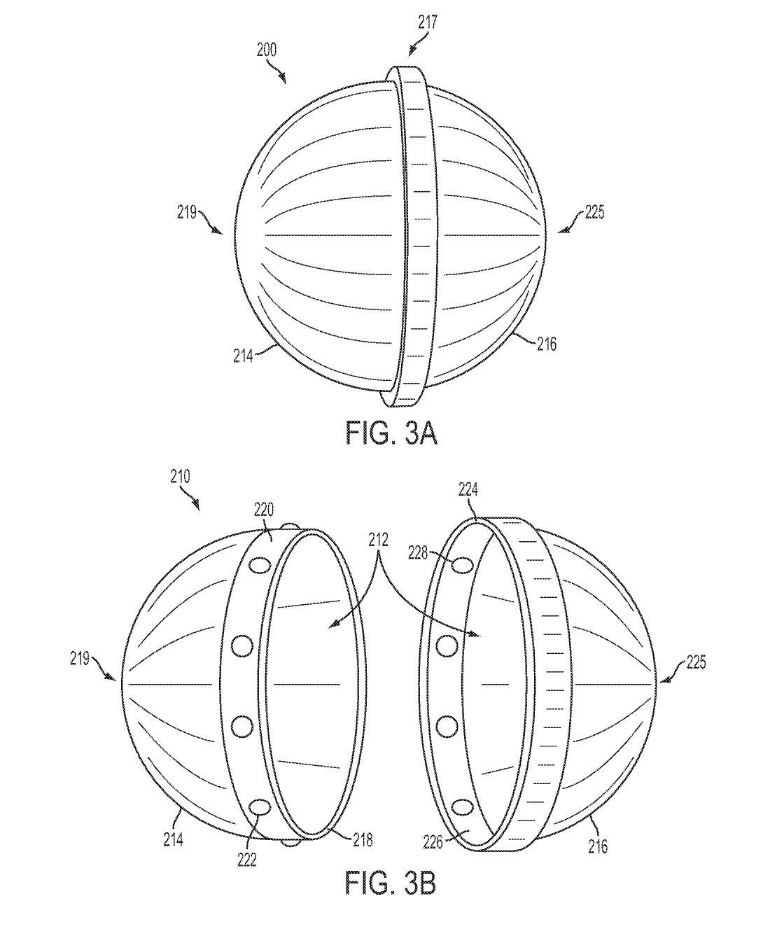

Referring now to FIG. 4, yet another alternate embodiment of a delivery container 180 in accordance with the present disclosure is shown. Delivery container 180 includes a cylindrical interior compartment 182 that is defined by its body 184 and lid 198. Body 184 includes a circular base wall 186 and a cylindrical side wall 188 that extends therefrom and terminates in a circular rim 190. Circular lid 198 is secured to rim 190 of body 184 by a pair of projections 194 that extend radially outwardly from rim 190 and are selectively receivable and a pair of apertures 196 defined by lid 198. An elongated handle 199 extends outwardly from base wall 186 of body 184 along the longitudinal center axis of body 184. Delivery container 180 is preferably formed of an injection molded polypropylene, or other like material, that is lightweight, shatter resistant and heat resistant. As well, delivery container 180 is preferably formed of a translucent or transparent material. This allows a light source such as, but not limited to, an LED light, light stick, etc., to be placed in the delivery container yet remain visible to a potential evacuee that is attempting to locate the emergency escape breathing system 100.

Referring now to FIG. 5, various items that may be disposed within the delivery container of the disclosed emergency escape breathing system are discussed. As shown, where the size of the delivery container allows, each emergency escape breathing system preferably includes at least a smoke filtration mask 102, a pair of goggles 104, an LED light 106, and a whistle 108, for use by a potential evacuee 105 of a burning structure. Smoke filtration mask 102 and goggles 104 are both formed of pliant materials, allowing them to be folded for placement in the desired delivery container of the emergency escape breathing system. As well, their foldability allows the overall size of the delivery container to be minimized to facilitate delivery of the emergency escape breathing system, such as by throwing, into the burning structure. Example emergency escape items such as those shown are available from Xcaper Industries LLC, Irvine, Calif. 92614.

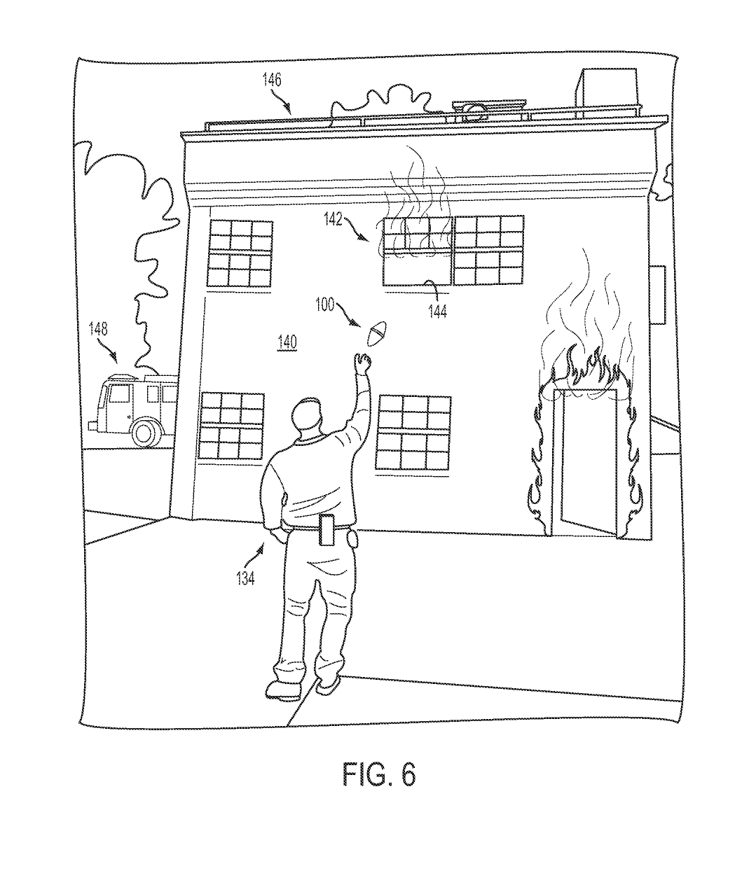

Referring additionally to FIG. 6, emergency escape breathing system 100, as shown in FIGS. 1A and 1B, is being delivered into a burning structure 140 through a window opening 142. As previously noted, the football-shaped delivery container 110 of emergency escape breathing system 100 facilitates the user in being able to throw emergency escape breathing system 100 through small openings, such as a sill 144 of a window. First, because delivery container 110 is substantially football-shaped, many users will be adept at throwing it, as well as the shape providing accuracy through gyroscopic stabilization. As well, the rounded apexes 119 and 125 of delivery container 110 increase the chances that the delivery container will enter the opening although it may hit the perimeter of the opening, such as a sill 144 of a window. Specifically, the rounded apexes increase the chance that any contact with the perimeter of the opening may still result in the delivery container being deflected inwardly into the opening. Emergency escape breathing system 100 may also be thrown onto alternate areas of a burning structure 140 such as its roof 146, where a potential evacuee may be trapped by smoke and/or flames. Emergency escape breathing system 100 allows potential evacuees 105 (FIG. 5) to receive those items that may allow them to egress the burning structure, or alternately await the arrival of an emergency escape vehicle 148, such as a fire engine. Preferably, delivery container 110 is of a size that a typical 10-year old would be comfortable throwing. Note, however, larger sizes may be used to facilitate placement of additional items inside the container.

While one or more preferred embodiments of the invention are described above, it should be appreciated by those skilled in the art that various modifications and variations can be made in the present invention without departing from the scope and spirit thereof. For example, alternate embodiments of emergency escape breathing systems in accordance with the present disclosure may have alternately shaped delivery containers, alternate items disposed within the container, delivery containers forced to alternate materials, etc. It is intended that the present invention cover such modifications and variations as come within the scope and spirit of the appended claims and their equivalents.

What is claimed is:

1. An emergency escape breathing system, comprising:
a delivery container including a first portion and a second portion that are releasably secured to each other, the delivery container defining an interior compartment; and
a smoke filtration mask disposed within the interior compartment of the delivery container,
wherein the delivery container is configured so that the emergency escape breathing system may be grasped and thrown by a hand of a user.

2. The emergency escape breathing system of claim 1, wherein:
the first portion of the delivery container is substantially cone shaped, having a cylindrical rim at a first end and terminating in a rounded apex at a second end, and
the second portion is substantially cone shaped, having a cylindrical rim at a first end and terminating in a rounded apex at a second end.

3. The emergency escape breathing system of claim 1, wherein a cross-section of the delivery container is substantially oval as defined by a plane passing through a longitudinal center axis of the delivery container.

4. The emergency escape breathing system of claim 1, wherein a cross-section of the delivery container is substantially circular as defined by a plane passing through a center of the delivery container, the plane being transverse to a longitudinal center axis of the delivery container.

5. The emergency escape breathing system of claim 1, wherein the delivery container is substantially round.

6. The emergency escape breathing system of claim 1, wherein:
the first portion of the delivery container is substantially cylindrical, defining a substantially cylindrical interior compartment, and
the second portion of the delivery container is substantially cone shaped.

7. The emergency escape breathing system of claim 6, wherein the second portion of the delivery container is comprised of a foam material.

8. The emergency escape breathing system of claim 6, wherein one of the first portion and the second portion of the delivery container includes a pair of projections and the other of the first portion and the second portion of the delivery container includes a pair of apertures for releasably receiving the pair of projections, thereby connecting the first portion to the second portion.

9. The emergency escape breathing system of claim 3, wherein a first end of the first portion of the delivery container includes a plurality of radially extending projections, a first end of the second portion of the delivery container includes a plurality of recesses, each recess being configured to receive a corresponding radially extending projection, thereby releasably securing the first portion of the delivery container to the second portion of the delivery container.

10. The emergency escape breathing system of claim 3, wherein a first end of the first portion of the delivery container and a first end of the second portion of the delivery container are correspondingly threaded so that the first portion of the delivery container is releasably securable to the second portion of the delivery container.

11. The emergency escape breathing system of claim 1, wherein the first portion of the delivery container comprises a cylindrical body including a lid, and the second portion of the delivery container comprises an elongated handle extending outwardly from a base of the cylindrical body.

12. The emergency escape breathing system of claim 11, wherein the lid is releasably secured to the cylindrical body.

13. An emergency escape breathing system, comprising:
a delivery container including a first portion and a second portion that are releasably secured to each other, the delivery container defining an interior compartment and being comprised of a translucent material;
a smoke filtration mask disposed within the interior compartment of the delivery container; and
a light source disposed within the interior compartment of the delivery container, the light source being visible through the delivery container,
wherein the delivery container is configured so that the emergency escape breathing system may be grasped and thrown by a hand of a user.

14. The emergency escape breathing system of claim 13, wherein:
the first portion of the delivery container is substantially cone shaped, having a cylindrical rim at a first end and terminating in a rounded apex at a second end, and
the second portion is substantially cone shaped, having a cylindrical rim at a first end and terminating in a rounded apex at a second end.

15. The emergency escape breathing system of claim 13, wherein a cross-section of the delivery container is substantially oval as defined by a plane passing through a longitudinal center axis of the delivery container.

16. The emergency escape breathing system of claim 15, wherein a first end of the first portion of the delivery container includes a plurality of radially extending projections, a first end of the second portion of the delivery container includes a plurality of recesses, each recess being configured to receive a corresponding radially extending projection, thereby releasably securing the first portion of the delivery container to the second portion of the delivery container.

17. The emergency escape breathing system of claim 15, wherein a first end of the first portion of the delivery container and a first end of the second portion of the delivery container are correspondingly threaded so that the first portion of the delivery container is releasably securable to the second portion of the delivery container.

18. The emergency escape breathing system of claim 13, wherein a cross-section of the delivery container is substantially circular as defined by a plane passing through a center of the delivery container, the plane being transverse to a longitudinal center axis of the delivery container.
